(19) United States
(12) Patent Application Publication
(10) Pub. No.: US 2007/0294283 A1
(43) Pub. Date: Dec. 20, 2007

(54) SYSTEM, METHOD AND SOFTWARE APPLICATION FOR MANAGING META-LANGUAGE DOCUMENTS

(75) Inventor: Philip Ross MACKAY, Glenbrook (AU)

Correspondence Address: STITES & HARBISON PLLC, 1199 NORTH FAIRFAX STREET, SUITE 900, ALEXANDRIA, VA, 22314, US

(73) Assignee: Julie Michelle MaCkay, Glenbrook (AU)

(21) Appl. No.: 11/758,831

(22) Filed: Jun. 6, 2007

(30) Foreign Application Priority Data
Jun. 6, 2006 (AU) 2006903049

(51) Int. Cl. G06F 7/00

(52) U.S. Cl. 707/102

(57) ABSTRACT

The present invention provides a system and method for managing meta-language documents. In particular, the system and method receive Delta documents specifying the exact locations of changes required in a meta-language document and process the meta-language document to produce an updated meta-language document.

### FIELD OF THE INVENTION

The present invention relates generally to a system and method for managing meta-language documents. Particularly, but not exclusively, the present invention includes methodologies for managing changes to XML documents.

### BACKGROUND OF THE INVENTION

Systems for merging or updating XML documents are available. Where two XML documents are merged or an XML document is updated, the “difference” between an original XML document and an updated XML document is generally referred to as an XML “delta”.

Applications such as DeltaXML™, XyDelta™ and Microsoft® XML Diff Language are products that allow a user to compare and update XML documents. Such systems generally compare a modified XML document against an original XML document to produce to produce a delta describing the differences.

However, such systems, whilst suitable for so-called “static” document content, are not particularly suited to more fluid content (for example, where XML documents are being updated several times a second).

### SUMMARY OF THE INVENTION

In a first aspect, the present invention provides a system for modifying data in a meta-language document, comprising a processing module arranged to receive a delta document specifying the locations at which changes in the meta-language document are to be made, and processing the meta-language document to produce an updated meta-language document.

The delta document may be processed in an event driven manner.

There may be provided a pre-processing module arranged to receive any edit request, and process the edit request to produce the delta document.

The processing module may progress through the meta-language document utilising a change integration algorithm.

The changes may be provided in a language which allows a change to be expressed in only one manner.

The edit request may be a delta document.

The delta document may be compatible with the meta-language.

The correctness of the delta document may be verifiable by utilising a schema for the meta-language.

The meta-language may be XML.

In a second aspect, the present invention provides a method for merging two delta documents into a single delta document, comprising the steps of simultaneously navigating through each delta document in a cursor-like manner, and merging the resultant delta into a target delta document.

In a third aspect, the present invention provides a data structure utilised to locate a node in a meta-language document, comprising, a hash table utilised in conjunction with a tree structure to form a virtual array, wherein a node location may be located by firstly locating a value in the hash table, the value in the hash table being utilised to determine a corresponding location in the tree structure, wherein the location in the tree structure is utilised to determine the location of the node in the meta-language document.

### DETAILED DESCRIPTION OF THE DRAWINGS

Notwithstanding any other forms which may fall within the scope of the present invention, a preferred embodiment will now be described, by way of example only, with reference to the accompanying drawings in which:

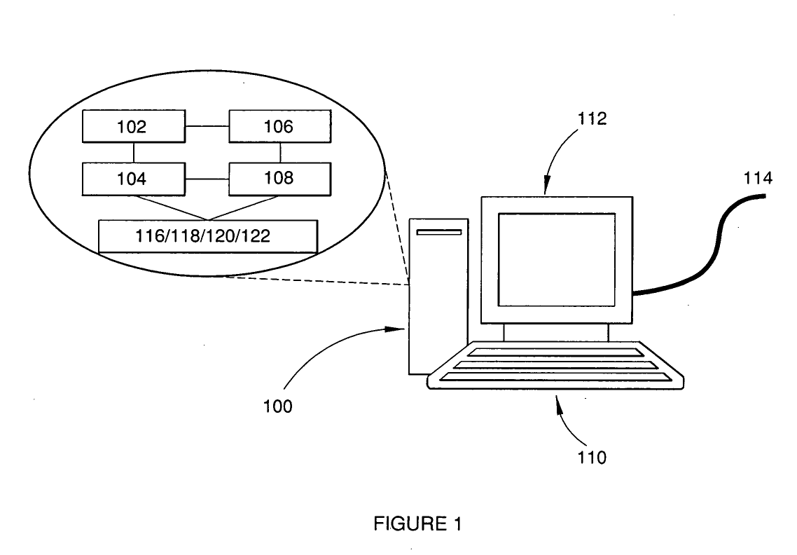

FIG. 1 is a computing system suitable for operating a software application in accordance with an embodiment of the present invention;

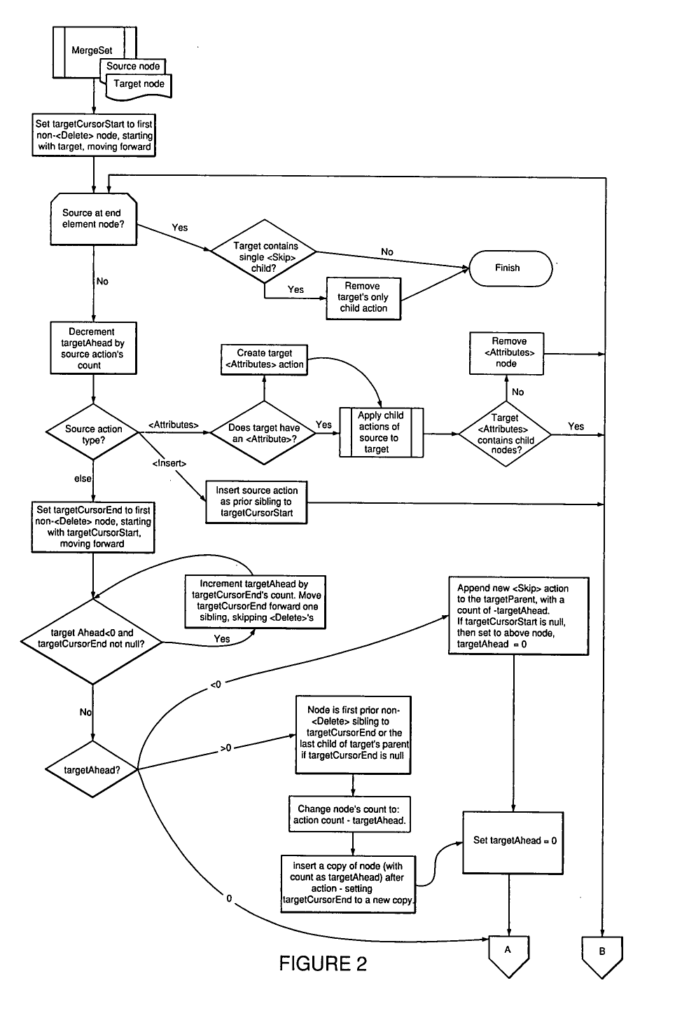

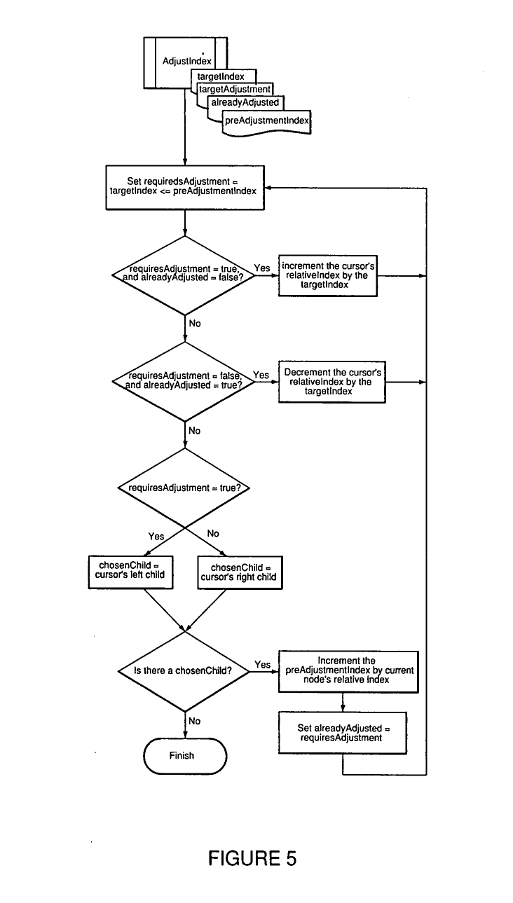

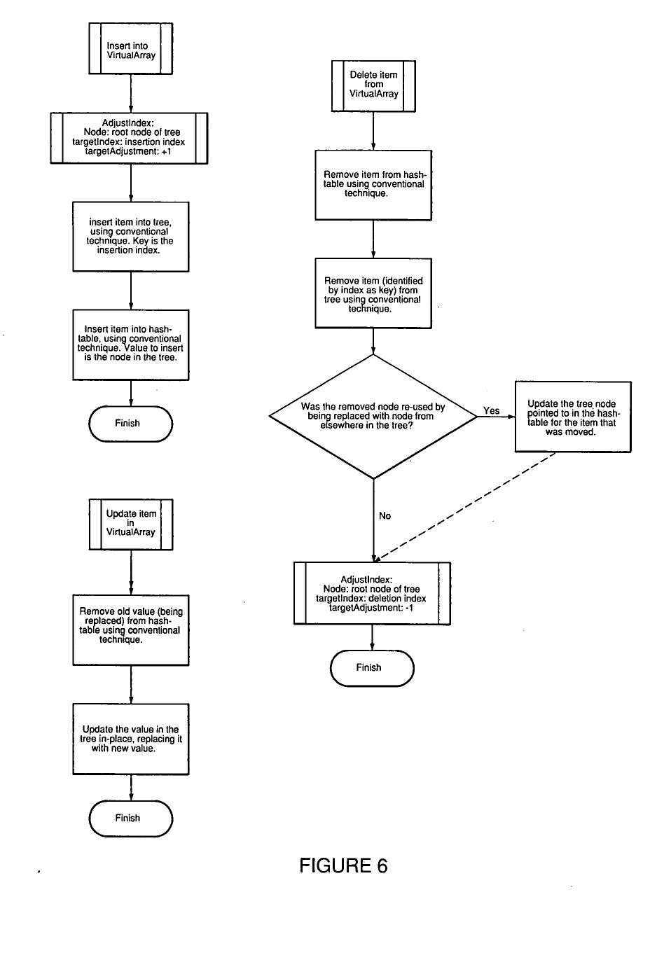

FIGS. 2 to 6 are flowcharts depicting a series of methodologies in accordance with an embodiment of the present invention; and

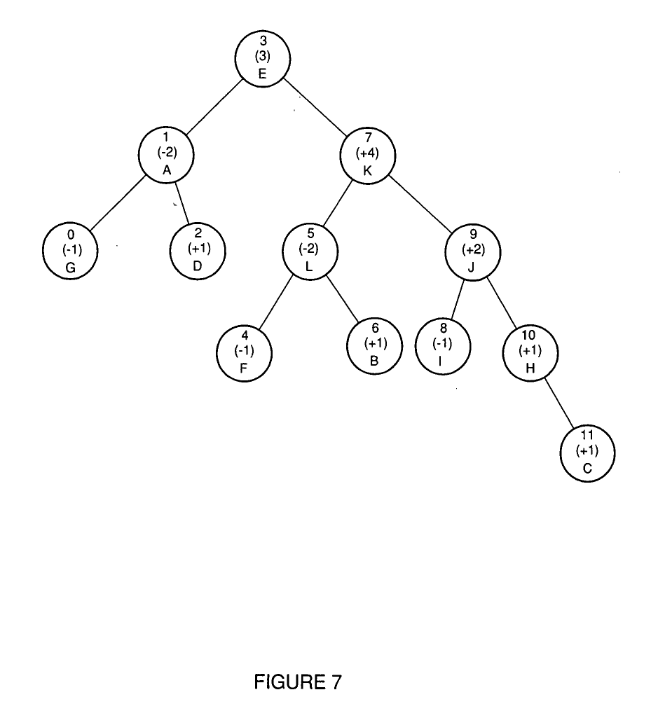

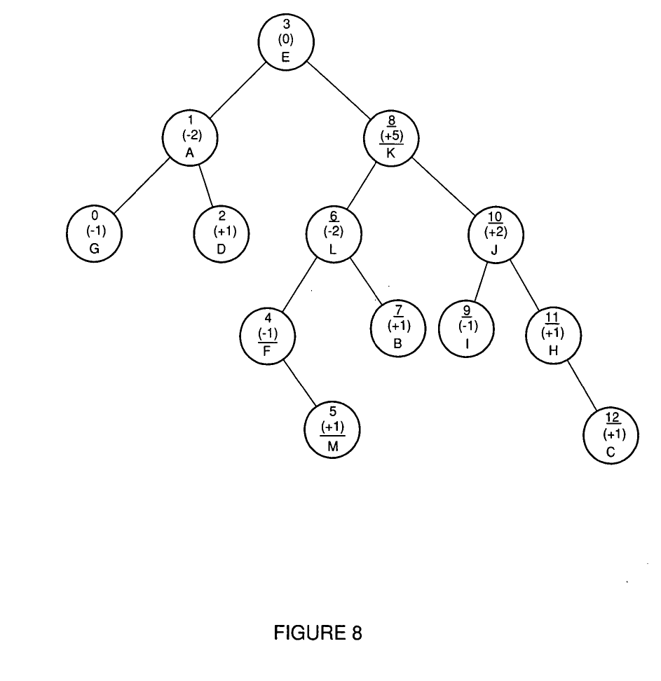

FIGS. 7 and 8 are illustrations of a tree-structure used to conduct a searching process in accordance with an embodiment of the present invention.

### DESCRIPTION OF A SPECIFIC EMBODIMENT

At FIG. 1 there is shown a schematic diagram of a computing system 100 suitable for use with an embodiment of the present invention. The computing system 100 may be used to execute applications and/or systems services such as a XML management application in accordance with an embodiment of the present invention. The computing system 100 preferably comprises a process 102 read only memory 104, random access memory 106 and input/output devices such as disc drives 108, keyboard 110, mouse 112, display 114, printer 116 and communications link 118. The computer includes programs that are stored in RAM 106, ROM 104 or disc drives 108 and may be executed by the processor 102. The communications link 118 connects to a computer network such as the Internet but may be connected to a telephone line, an antenna, a gateway or any other type of communications link. Disc drives 108 may include any suitable storage medium such as, for example, floppy disc drives, hard disc drives, CD ROM drives, DVD drives or magnetic tape drives. The computing system 100 may use a single disc drive or multiple disc drives. The computing system 100 may use any suitable co-operating system such as Windows® or UNIX®.

It will be understood that the computing system described in the preceding paragraphs is illustrative only and that an embodiment of the present invention may be executed on any suitable computing system, with any suitable hardware and/or software.

In one embodiment, the present invention is implemented as a software application 120 which interacts with XML documents 122, the software application 120 being executable on the computer system 100.

In the embodiment described, the software application performs a number of distinct functions. However, it will be understood that these functions may be performed individually by separate software modules which are incorporated into one software application, or alternatively, separate software applications may perform each function either singularly or in combination with other software applications.

An embodiment of the present invention is provided in a software application which is called SuperSet™ which is a framework for delivering dynamic data via XML documents.

SuperSet™ can conceptually be divided into four major components. The first is MotionSet™, which manages changes to an XML document and describes such changes in an XML based message format. The XML based message format is akin to a delta. An example implementation of MotionSet™ is provided at Annexure A.

The second component is MergeSet™, which is a method for merging several MotionSet™ delta's into a single delta such that the effect of the single delta is identical to that produced from the original deltas.

The third component is PublishSet™, which is a publishing protocol that utilises MotionSet™, and optionally MergeSet™ to deliver XML based information.

MotionSet™, as described above, is a software component which is capable of managing changes to an XML document. MotionSet™ provides a cursor-based document navigation mechanism, such that all changes in a document are performed in an iterative and cursor-based manner.

For example, consider a document:

```
<?xml version=“1.0” encoding=“UTF-8”?>
<x>
  <y/>
  <z/>
</x>
```

This then has element ‘z’ deleted, and has now become:

<?xml version=“1.0” encoding=“UTF-8”?>
<x>
<y/>
</x>

This is achieved by utilising the following MotionSet™ delta:

```
<Delta>
  <Skip/>
  <Node>
    <Skip/>
    <Delete/>
  </Node>
</Delta>
```

As can be seen from the above example, MotionSet™ describes the exact location in a document at which a change is to be made by navigating through the document in a-cursor-like manner.

This provides a number of distinct advantages not seen in other XML document change management systems.

Firstly, other XML document management systems generate deltas by comparing two XML documents and creating compensating actions to move a change from a first document to a second document. MotionSet™, in one embodiment, generates deltas from individual actions to the XML document as they occur in an event driven manner.

As a corollary, due to the nature of prior art solutions, the prior art formats are designed for large, relatively static documents that are not updated often. MotionSet™ is designed to be also capable of supporting highly volatile data that can potentially change several times a second (for example, engine sensors, GPS location, or market prices).

Secondly, the extremely simple format of the deltas generated by MotionSet™ and the ability to stream through XML documents in a cursor-like manner, allows MotionSet™ to apply changes more efficiently in terms of computing resources.

Thirdly, the simplicity of the MotionSet™ language only allows changes to be represented in one manner. This ensures that any required analysis on their due process is kept as simple as possible, also increasing efficiency.

As the delta may be represented as XML, it may be able to be validated via a XML schema.

The data format for MotionSet™ is disclosed at Annexure B.

The second component of the embodiment described herein is MergeSet™, which is utilised to merge two MotionSet™ deltas into a single delta. MotionSet™ does not use node identifiers (XID's or key values), to assist MergeSet™ in the process, unlike prior art methodologies for managing and merging deltas. MergeSet instead uses relative cursor-based navigations over the target document, in a manner analogous to MotionSet.

Moreover, due to the cursor-based movement, node identifiers do not need to be stored in parallel with the data. Therefore, no additional storage is required.

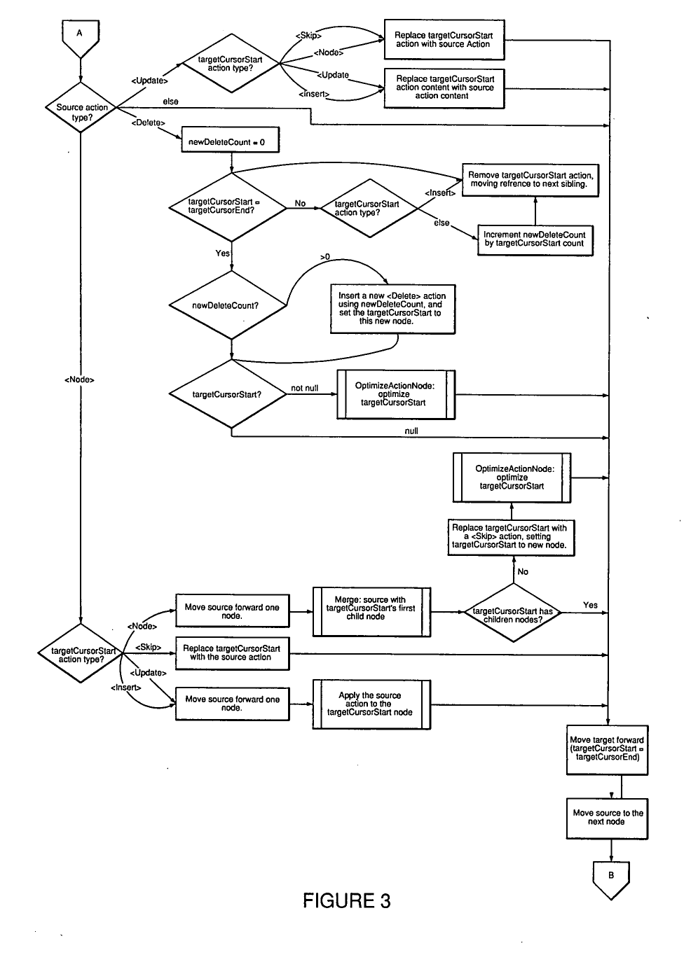

Merging deltas into a single delta that encapsulates the aggregate result of the two is achieved by reading (streaming) through a source delta, and merging its effect into an existing target delta. The two deltas are read in a synchronised fashion, using a cursor on each delta document—and advancing each to keep the same virtual position in the underlying document at all times. In other words, the cursor moves through both documents simultaneously. These processes are depicted in the flowcharts shown in FIGS. 2 and 3.

If actions are performed at identical nodes in the underlying document, the actions are merged together. Where the documents partially overlap, existing target delta nodes are split into fragments to ensure that the source can be discretely applied to create a single clear, consistent, and optimised representation of the aggregate.

For example, if delta “A” is:

```
<Delta>
  <Skip />
  <Node>
    <Node>
      <Attributes>
        <Skip count=“3”/>
        <Update value=“newValue”/>
        <Delete count=“2” />
      </Attributes>
      <Insert>
        <xxx attr1=“x” xmlns=“mynamespace”>
          xxx-text
        </xxx>
      </Insert>
    </Node>
  </Node>
</Delta>
```

While delta “B” is:

```
<Delta>
  <Skip />
  <Node>
    <Node>
      <Attributes>
        <Insert name=“newAttr” value=“newValue”/>
      </Attributes>
      <Node>
        <Attributes>
          <Insert name=“new” value=“val”/>
        </Attributes>
        <Node/>
        <Insert>
          <MyNode/>
        </Insert>
      </Node>
    </Node>
    </Delete>
  </Node>
</Delta>
```

When deltas “A” and “B” are merged: (“A+B”)

```
<Delta>
  <Skip />
  <Node>
    <Node>
      <Attributes>
        <Insert name=“newAttr” value=“newValue”/>
        <Skip count=“2”/>
        <Update value=“newValue”/>
        <Delete count=“2” />
      </Attributes>
      <Insert>
        <xxx new=“val” attr1=“x” xmlns=“mynamespace”>
          xxx-text
          <MyNode/>
        </xxx>
      </Insert>
    </Node>
    </Delete>
  </Node>
</Delta>
```

This merging process is performed in a simple, generic and iterative process to handle the myriad of possible permutations.

One advantage of this technique is that changes made earlier in a delta when merging do not affect subsequent actions, leading to simpler implementation, resource requirements and performance.

To demonstrate the merging process, take delta “C”;

C1: <Delta>
C2: <Skip />
C3: <Insert>
C4: <xxx xmlns=“mynamespace”/>
C5: </Insert>
C6: </Delta>

and delta “D”:

D1: <Delta>
D2: <Skip />
D3: <Delete />
D4: <Update>
D5: <yyy xmlns=“mynamespace”/>
D6: </Update>
D7: </Delta>

Node numbers have been added into the XML to assist with identifying nodes in the following example steps.

A merge operation is commenced with the source node pointing to D2, and target pointing to node C2. The steps are as follows:
1. targetCursorStart is set to the target node (C2)
3. As the source node is not an ‘end element’ node; Start loop:
4. Decrement targetAhead by the source action's count (1). Now targetAhead=−1
5. Source action is not an <Attributes> or <Insert>; continue
6. targetCursorEnd is set to targetCursorStart (C2)
7. Is targetCursorEnd a <Delete>? No; continue
8. Is targetAhead <0 and targetCursorEnd not null? Yes; Start loop:
9. Increment targetAhead by targetCursorEnd's count (1). Now targetAhead=0
10. Move targetCursorEnd forward one sibling. Now targetCursorEnd=C3
11. Finish loop from 8
12. Is targetAhead<0 and targetCursorEnd not null? No; exit loop:
13. targetAhead is 0; continue
14. Source action type is <Skip>; continue
15. Move target forward by setting targetCursorStart to equal targetCursorEnd. Now targetCursorStart=C3
16. Move source to next node; Now source=D3
17. Finish loop from 3
18. The source node is not an end-of-element node; Restart loop:
19. Decrement targetAhead by the source action's count (1). Now targetAhead=−1
20. Source action is not an <Attributes> or <Insert>; continue
21. targetCursorEnd is set to targetCursorStart (C3)
22. Is targetCursorEnd a <Delete>? No; continue
23. Is targetAhead<0 and targetCursorEnd not null? Yes; Start loop:
24. Increment targetAhead by targetCursorEnd's count (1). Now targetAhead=0
25. Move targetCursorEnd forward one sibling. Now targetCursorEnd=null
26. Finish loop from 23
27. Is targetAhead<0 and targetCursorEnd not null? No; exit loop:
28. Is targetAhead less than 0? No; continue
28A. Is targetAhead greater than 0? No; continue
29. Source action type is <Delete>; continue
30. Set newDeleteCount to 0
31. Does targetCursorStart (C3) not equal targetCursorEnd (null)? Yes; Start loop:
32. targetCursorStart action type is <Insert>? Yes;
33. Delete and insert cancel one-another out: set targetCursorStart to its next sibling (null), and remove the old targetCursorStart from the target XML document
34. Finish loop from 31
35. Does targetCursorStart (null) not equal targetCursorEnd (null)? No; Exit loop.
36. newDeleteCount>0? No; continue
37. targetCursorStart is not null? No; continue
38. Move target forward: set targetCursorStart=targetCursorEnd. Now targetCursorStart null
39. Move source to next node; Now source=D4
40. Finish loop from 18
41. Is the source node (D4) an ‘end element’ node? No; Restart loop:
42. Decrement targetAhead by the source action's count (1). Now targetAhead=−1
43. Source action is not an <Attributes> or <Insert>; continue
44. targetCursorEnd is set to targetCursorStart (null)
45. Is targetCursorEnd a “<Delete>” action element? No; continue
46. Is targetAhead <0 and targetCursorEnd not null? No; exit loop:
47. Is targetAhead less than 0? Yes:
48. Set skipNodeCount to minus targetAhead
49. Create a new XML action element “<Skip>”, as skipNode
50. If skipNodeCount does not equal 1, then create an attribute in the skipNode element called “count”, setting the value to skipNodeCount.
51. Does targetCursorStart equal null? Yes: set targetCursorStart to equal skipNode
52. Set targetAhead to 0
53. Determine the source action; source is <Update>; continue:
54. Is targetCursorStart's action a <Node> or <Skip> element? Yes;
55. Replace the node targetCursorStart in the XML document, with the source node (including children). The source node should be advanced to the next sibling.
56. Set targetCursorStart to the new node that replaced the old in the previous step (<Update>).
57. Move target forward: set targetCursorStart=targetCursorEnd (null)
58. Move source to next node; Now source=D7
59. Finish loop from 41
60. Is the source node (D7) an ‘end element’ node? Yes; exit loop:

Deltas “C” and “D” are merged: “C+D”

```
<Delta>
  <Skip />
  <Update>
    <yyy xmlns=“mynamespace”/>
  </Update>
</Delta>
```

XML documents can become very large, which correspondingly causes delays in searching for specific data within such documents.

For example, when a change is made to a document from which a MotionSet™ is required to create a corresponding delta description, one of the steps required is to find a given node, in a potentially large list of sibling nodes (as XML nodes are ordered and as such may not be sorted to improve performance). This is problematic since linear searching is an extremely inefficient method.

In other words, where an ordered array of items exists with no key other than the index to identify each item, there are no efficient ways to find the index of a particular item. Creating a conventional index, in the form of a hash-table or other such technique (to map between the item data type and the index) is one way to improve the search time. However this table must be regenerated after each insertion/deletion, since the index will change for all items subsequent to the affected item in the ordered arrays.

To satisfy the requirements of a changing ordered array which requires fast retrieval of the index of a particular item in the array, a new approach is needed.

The applicant proposes the novel technique of combining a traditional hash-table, with a customised sorted tree implementation (such as red-black tree) to provide a “virtual array”. This virtual array provides efficient access via index and value lookup, and also efficiently handles insert/change/delete actions to the array items. If the type of the items required to be stored in the ordered array is referred to as type “X”.

The hash-table is keyed on “X”, using traditional hashing/searching algorithms, and contains a reference to the node within the tree that refers to the item.

The tree is keyed by the index of the item within the virtual array, and contains the data for “X”. The tree is different however, in that it does actually store the index value in each node literally, but instead stores the “relative index”, relative to the index of its parent in the tree. Only the root node stores an absolute index. The absolute index for any other node is always calculated, and never stored.

The tree's implementation is also modified from that of a standard ordered tree so that:
1. Changing the parent of a node does not cause a change in the absolute index. This is done by compensating the relative index by adding to it: the old parent's absolute index minus the new parent's absolute index.
2. Changes to a node's absolute index do not cause a change to the child nodes absolute index. This is done by adjusting the child nodes relative index by subtracting from them: the new absolute index minus old absolute index.

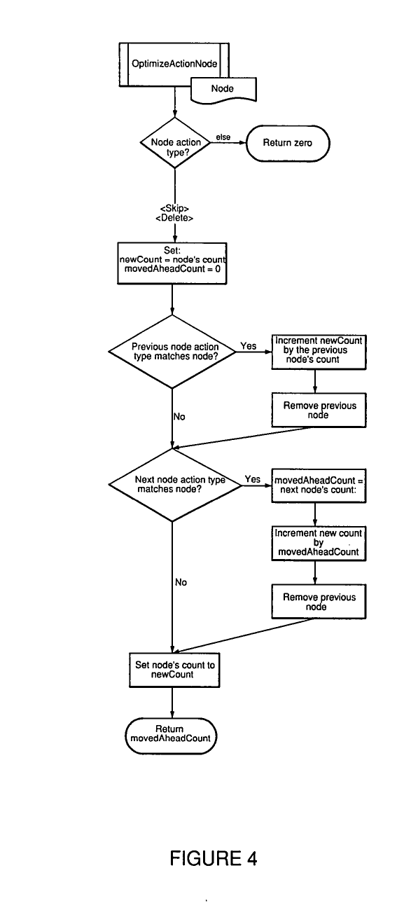

The flowcharts of FIGS. 4, 5 and 6 describe the generic method steps for inserting, deleting and modifying values in the array and tree. These processes are described in detail below.

If it is necessary to determine the index for an item “Z” within the virtual array the steps are as follows:
1. Item Z is located in the hash-table using an appropriate search algorithm;
2. The reference to the corresponding node in the tree is obtained;
3. The node's ancestry is navigated, adding up all the relative index values up to and including the root node—to determine the absolute index of “Z”.

Changes to the virtual array contents requires the index values stored in the tree to be updated in an efficient manner. Changes to the index values can be applied generically using the “adjust index” process:
1. A cursor is pointed at the root node in the tree, and adjustment is applied to this node supplying: a preAdjustmentIndex being the root node's absolute index, a targetIndex being the index value at which the insertion/deletion is taking place, and indicating it has not already been adjusted.
2. The node is tested to see if an index adjustment is required, being if the supplied targetIndex is less than or equal to the supplied preAdjustmentIndex.
3. If the node needs adjustment, and it has not been pre-adjusted, then the relative index has the supplied targetAdjustment added to it; otherwise:
4. If the node does not need adjustment, and it has been pre-adjusted, then the relative index has the supplied targetAdjustment negated from it.
5. Determine the children for which this adjustment is relevant: if this node needed adjustment, then all children covering index values less than this node are relevant; otherwise children covering index values greater-than this node are relevant
6. For any relevant children, perform the same operation above from step 2. The preAdjustmentIndex is incremented by the current child's relative index, and the adjustment state for the child node is set to whether the current node was adjusted.

Items may be inserted efficiently into the virtual array by using the following steps:
1. Call the “adjust index” process, using the insertion index as the targetIndex, and +1 as the targetAdjustment.
2. Perform a standard insertion into the ordered tree using the appropriate insertion algorithm, using the supplied index as the key.
3. Add the item “Z” to the hash-table using the appropriate insertion algorithm, with the entry pointing to the new node created in step 2.

Items may be deleted efficiently from the virtual array by using the following steps:
1. Remove the item “Z” from the hash-table using the appropriate deletion algorithm.
2. Perform a standard deletion from the ordered tree using the appropriate deletion algorithm, using the supplied index as the key.
3. Check to see if the node deleted in step 1 was in fact replaced with another node (copied from elsewhere in the tree). If it was, then update the hash-table to reflect the fact that the node that was moved has a new node reference.
4. Call the “adjust index” process, using the deletion index as the targetIndex, and −1 as the targetAdjustment.

When items are updated, in other words “Z” is changed in value—without its position in the virtual array changing, the following steps are performed:
1. The old value for “Z” is removed from the hash-table.
2. The data is updated in the tree node in-place, as would normally be the case with an ordered tree implementation.
3. A new hash-table entry is created, mapping the new value for “Z” to the tree node that relates to “Z”.

Utilising the virtual array, the task of determining the index of a given XML node as a result of a change event being fired, is now achievable without resorting to a linear search, or regenerating an index after each change.

For example, the following data exists within an array:

| Index: | Value: |
|---|---|
| 0 | G |
| 1 | A |
| 2 | D |
| 3 | E |
| 4 | F |
| 5 | L |
| 6 | B |
| 7 | K |
| 8 | I |
| 9 | J |
| 10 | H |
| 11 | C |

This data is manifest within a virtual array using the following hash table and red-black tree (shown FIG. 7):

| B: | Index: |
|---|---|
| A | node “1” |
| B | node “6” |
| C | node “11” |
| D | node “2” |
| E | node “3” |
| F | node “4” |
| G | node “0” |
| H | node “10” |
| I | node “8” |
| J | node “9” |
| K | node “7” |
| L | node “5” |

The conventions used for the nodes in the tree are as follows, for example:

7—Absolute index (derived: sum of ancestors)

(+4)—Relative index (stored)

K—Data value

Items can be quickly found via index (using the tree), or value (using hash-table), and updates to the underlying data can be handled.

For example, adding a new item “M” at index #5 such that the array looks like the following:

| Index: | Value: |
|---|---|
| 0 | G |
| 1 | A |
| 2 | D |
| 3 | E |
| 4 | F |
| 5 | M |
| 6 | L |
| 7 | B |
| 8 | K |
| 9 | I |
| 10 | J |
| 11 | H |
| 12 | C |

The hash-table and tree representation are now:

| Hash Value: | Index: |
|---|---|
| A | node “1” |
| B | node “7” |
| C | node “12” |
| D | node “2” |
| E | node “3” |
| F | node “4” |
| G | node “0” |
| H | node “11” |
| I | node “9” |
| J | node “10” |
| K | node “8” |
| L | node “6” |
| M | node “5” |

Note that changes to the data structures above are highlighted to add clarity.

On inserting the new node into the tree, nodes “8” and “4” have their relative index changed. The result of these changes is very large, flowing through to the derived absolute indexes of 8 nodes in total. This is the number of changes that would have been required if a conventional hash-table was being used—requiring all subsequent items in the index to be individually incremented.

A sample implementation of Virtual Array is provided at Annexure C.

It will be understood that the embodiment described herein is illustrative of the invention, but should not be considered limiting. Other embodiments may be contemplated without departing from the underlying concept of the invention.

### ANNEXURE B

MotionSet™ Delta Document Format

This section describes the MotionSet delta document format, which is XML-based.

An example MotionSet™ delta follows:

```
<Delta>
  <Skip />
  <Node>
    <Node>
      <Attributes>
        <Skip count=“3”/>
        <Update value=“newValue”/>
        <Delete count=“2” />
      </Attributes>
      <Insert>
        <xxx xmlns=“mynamespace” attr1=“x”>
          xxx-text
        </xxx>
      </Insert>
    </Node>
  </Node>
</Delta>
```

Root Element

The root element for the document is “Delta”—designating the appropriate SuperSet™ namespace:

<Delta>

This root element corresponds to the DOM document—that is the node that contains the (optionally) XML declaration, and the document element. Therefore the ‘root’ document element is actually the second level in the delta.

<Delta> and <Node> Actions

These elements contain a series of hierarchical actions—navigation and data manipulation instructions (insert/update/delete) which are applied using a cursor in the underlying document.

| NODE ACTIONS: | DESCRIPTION: |
|---|---|
| <Skip count=“n”/> | Moves the cursor forward by ‘n’ |
| | (defaults to 1) nodes. |
| <Node>[actions]</Node> | Moves the cursor to the first child |
| | of the current cursor node, and |
| | processes the [actions] |
| | against the children. |
| <Insert><newNode></Insert> | Inserts a new user-specified single |
| | node as a previous sibling to the |
| | current cursor node. The cursor |
| | remains at the same node, |
| | subsequent to the new node. |
| <Update><updatedNode></Update> | Replaces the current cursor node |
| | with the supplied single node. |
| <Delete count=“n”/> | Removes ‘n’ (defaults to 1) current |
| | cursor and subsequent nodes. |
| <Attributes>..actions..</Attributes> | Moves the cursor to the first |
| | attribute of the current element |
| | node, and processes the [actions] |
| | against the attributes. |
| | Note: Only used on element nodes. |

<Attributes> Actions

These actions describe changes to a collection of attributes in a given element, in a consistent cursor-based manner:

| ATTRIBUTE ACTIONS: | DESCRIPTION |
|---|---|
| <Skip count=“n”/> | Moves the cursor forward by ‘n’ |
| | (defaults to 1) attributes. |
| <Insert name=“x” value=“y”/> | Insert a new attribute at the current |
| | cursor, with the supplied value. The |
| | cursor remains at the same attribute, |
| | subsequent to the new attribute. |
| <Update value=“newValue”/> | Replaces the current cursor attribute |
| | with the supplied single node. |
| <Delete count=“n”/> | Removes ‘n’ (defaults to 1) current and |
| | subsequent attributes. |

The claims defining the invention are as follows:

1. A system for modifying data in a meta-language document, comprising a processing module arranged to receive a delta document specifying the exact locations at which changes in the meta-language document are to be made, and processing the meta-language document to produce an updated meta-language document.

2. A system in accordance with claim 1, wherein the delta document is processed in an event driven manner.

3. A system in accordance with claim 1, further comprising a pre-processing module arranged to receive any edit request, and process the edit request to produce the delta document.

4. A system in accordance with claim 1, wherein the processing module progresses through the meta-language document utilising a change integration-algorithm.

5. A system in accordance with claim 1, wherein the changes are provided in a language which allows a change to be expressed in only one manner.

6. A system in accordance with claim 2, wherein the edit request is a delta document.

7. A system in accordance with claim 1, wherein the delta document is compatible with the meta-language.

8. A system in accordance with claim 7, wherein the correctness of the delta document is verifiable by utilising a schema for the meta-language.

9. A system in accordance with claim 1, wherein the meta-language is XML.

10. A method for merging two delta documents into a single delta document, comprising the steps of simultaneously navigating through each delta document in a cursor-like manner, and merging the resultant delta into a target delta document.

11. A method in accordance with claim 10, comprising the further step, where delta documents overlap, of splitting delta nodes into fragments, and directly applying the fragments to the target delta document.

12. A data structure utilised to locate a node in a meta-language document, comprising, a hash table utilised in conjunction with a tree structure to form a virtual array, wherein a node location may be located by firstly locating a value in the hash table, the value in the hash table being utilised to determine a corresponding location in the tree structure, wherein the location in the tree structure is utilised to determine the location of the node in the meta-language document.

13. A data structure in accordance with claim 12, wherein each node of the tree structure contains a relative index corresponding to the location of the node in the meta-language document.

14. A data structure in accordance with claim 13, wherein the absolute location of a node in the meta-language document is calculated by the addition of the relative index of the node in the tree structure and all parent nodes of the relative node in the tree structure.

15. A data structure in accordance with claim 12, wherein the meta-language is XML.

16. A method of updating a tree structure in accordance with claim 12, comprising the steps of determining a pre-adjustment index that reflects the value at which the change in a meta-language document has occurred, and supplying the pre-adjustment index to all nodes in the tree structure.
